(19) United States
(12) Patent Application Publication
(10) Pub. No.: US 2009/0034451 A1
(43) Pub. Date: Feb. 5, 2009

(54) System and method for handling QoS flows in a roaming scenario

(75) Inventor: Chandra Warrier, (US)

Correspondence Address: UTSTARCOM, INC., 3800 GOLF ROAD, SUITE 220, ROLLING MEADOWS, IL, 60008, US

(73) Assignee: UTStarcom, Inc.

(21) Appl. No.: 11/890,085

(22) Filed: Aug. 3, 2007

(51) Int. Cl. H04Q 7/00; H04L 12/56; H04Q 7/20

(52) U.S. Cl. 370/328; 370/331; 370/389; 370/401; 455/432.1; 455/433; 455/445

(57) ABSTRACT

A system and method for transmitting a packet in a network is described. The method includes establishing a session with a flow identifier between a mobile station and a roaming wireless access gateway via a radio access network. A communication link is established between a home wireless access gateway and the roaming wireless access gateway. A filter is maintained at the home wireless access gateway for packet flow between the home wireless access gateway and the mobile station. The flow identifier is identified for a packet received by the home wireless access gateway from the network. The packet is transmitted with the flow identifier from the home wireless access gateway to the roaming wireless access gateway. The session for the packet is identified the via the flow identifier. Systems and method for establishing a call are also described.

### BACKGROUND

The invention relates generally to communication systems and more specifically to wireless communication systems.

In wireless communication systems such as Code Division Multiple Access (CDMA) systems, the mobile telecommunication systems provide different services to various users or subscribers of wireless communication devices. The wireless communication devices may be mobile or fixed units and situated within a geographic region across one or more wireless networks. The users of wireless communication devices, such as mobile stations (MSs) may constantly move within or outside the wireless networks. A wireless communications system generally includes one or more base stations (BSs) that can establish wireless communications links with MSs.

Several systems, such as Evolved Data Optimized (EVDO), for example EVDO (RevO and RevA), Evolution Data Voice (EVDV), High Speed Downlink Packet Access (HSDPA), and the like, have evolved over time to cater to the needs of high rate packet data systems in wireless communication systems. In these high-speed wireless data networks, stringent Quality of Service (QoS) requirements have also been introduced for better management of radio frequency (RF) resources, such as control of transmission power in a wireless communication link.

In an EVDO RevA system, an MS establishes multiple service instances or sessions with a BS. Each such session has a specific Quality of Service (QoS) characteristic. Once these sessions are established, the MS maps IP packet flows to these sessions and transmits this packet flow-to-session mapping information to the network so that IP packets matching a certain flow can be placed into the appropriate session.

The creation of the session and the packet flow-to-session map is exchanged between the MS and BS and Packet Data Serving Node (PDSN) via Radio Access Network (RAN)-PDSN signaling messages, such as A10 or A11 signaling messages. Another packet filter-to-flow map is exchanged between the MS and the PDSN via Resource Reservation Setup Protocol (RSVP) messages. This packet-filter-to-flow map filters the packets received thereby allowing only packets intended for the flow.

Typically in a roaming situation, the A10/A11 session is established with a PDSN in the roaming network. The Point-to-Point Protocol (PPP) is terminated in the home network via a Level 2 Tunneling Protocol (L2TP) tunnel between the PDSN L2TP Access Concentrator (LAC) of the roaming partner and the PDSN L2TP Network Server (LNS) of the home provider. However, in cases where the packet flow-to-session mapping is available at the PDSN (LAC) of the roaming partner, and the packet-filter-to-flow mapping is available at the home PDSN. (LNS), there is a mismatch. This is because the RSVP messages from the MS are sent to the PPP endpoint. Thus, when a packet is received from the network, the roaming PDSN (LAC) does not receive flow information for the packet from the home PDSN (LNS). Therefore, the roaming PDSN (LAC) is not able to determine the appropriate session for the packet. Consequently, the MS is not granted the correct QoS for packet flows.

Therefore, there exists a need for a technique for maintaining the high QoS standards for the packet flows while providing traffic in the appropriate session.

### SUMMARY

In accordance with one aspect of the present technique, a system and method for transmitting a packet in a network is provided. The method includes establishing a session with a flow identifier between a mobile station and a roaming wireless access gateway via a radio access network. A communication link is established between a home wireless access gateway and the roaming wireless access gateway. A filter is maintained at the home wireless access gateway for packet flow between the home wireless access gateway and the mobile station. The flow identifier is identified for a packet received by the home wireless access gateway from the network. The packet is transmitted with the flow identifier from the home wireless access gateway to the roaming wireless access gateway. The session for the packet is identified via the flow identifier.

In accordance with another aspect, a system and method for establishing a call to a mobile station in a roaming network is presented. The method includes establishing a packet flow session with a flow identifier between a mobile station and a roaming wireless access gateway. A communication link is established between a home wireless access gateway and the roaming wireless access gateway. A filter is maintained at the home wireless access gateway for packet flow between the home wireless access gateway and the mobile station. The flow identifier for a packet received by the home wireless access gateway from the network is identified and the packet is transmitted with the flow identifier from the home wireless access gateway to the roaming wireless access gateway. The session for the packet is identified via the flow identifier at the roaming wireless access gateway and the packet is transmitted to the mobile station. The packet is combined with other packets for delivering a call to the mobile station.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of an exemplary wireless communication network, in accordance with aspects of the present technique;

FIG. 2 is a schematic representation of an exemplary packet flow within the wireless communication network of FIG. 1, in accordance with aspects of the present technique; and

FIG. 3 is a flowchart illustrating the packet flow shown in FIG. 2 in the wireless communication network of FIG. 1.

### DETAILED DESCRIPTION OF EXEMPLARY EMBODIMENTS

In the subsequent paragraphs, an approach for transmission of packets in a network, such as a wireless network, with improved Quality of Service (QoS) characteristics, will be explained in detail. The approach presented hereinafter describes a technique for accurately identifying traffic flow in sessions for placing packet traffic in appropriate sessions when a call is established in the network. As will be appreciated by those of ordinary skill in the art, the technique is applicable to various communication systems that utilize packet-based traffic for transmission of calls within the network. Indeed, the exemplary uses and implementations described herein are merely provided as examples to facilitate understanding of the presently contemplated techniques. Therefore, the various aspects of the present technique will be explained, by way of example only, with the aid of figures hereinafter.

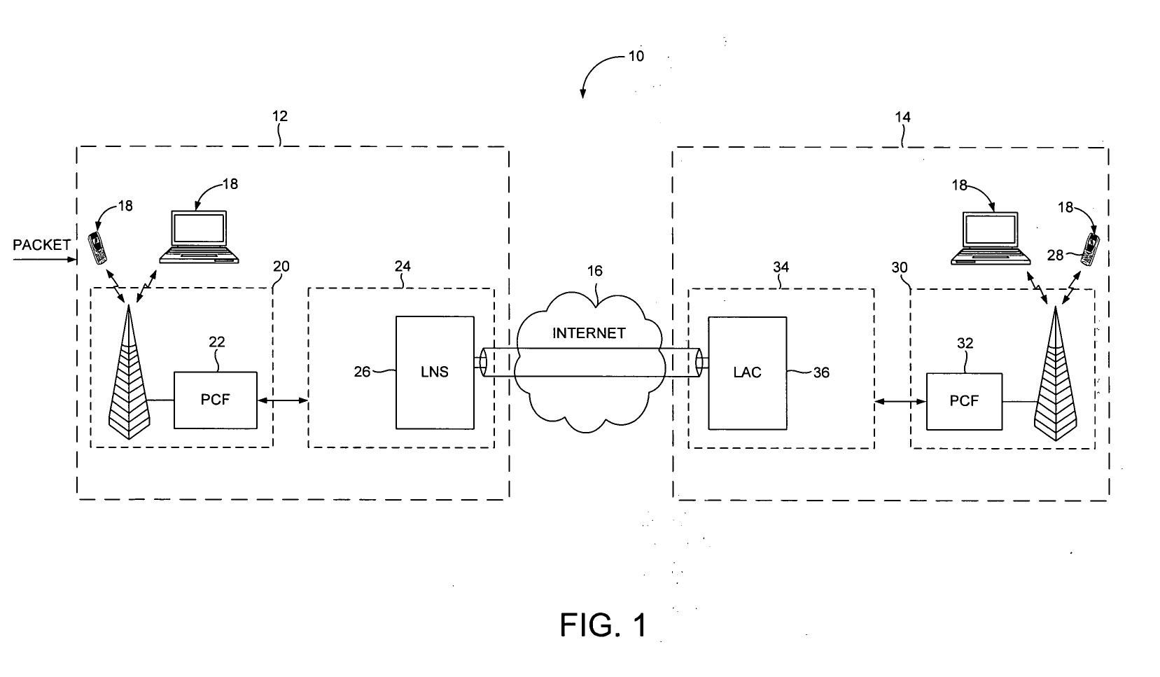

Referring generally to FIG. 1, transmission of packets in a network will be described by reference to an exemplary wireless communication network designated generally by numeral 10. It should be appreciated however, that the techniques for transmission of packets may find application in a range of settings and systems, and that its use in the wireless communication network 10 described herein is but one such application. As will be explained in detail, the techniques described herein are equally applicable to wireless transmission systems and devices, such as mobile telecommunication systems like Global System for Mobile Communications (GSM) systems, Code Division Multiple Access (CDMA) systems, Evolved Data Optimized (EVDO), for example EVDO RevO and EVDO RevA, Evolution Data Voice (EVDV), High Speed Downlink Packet Access (HSDPA), Enhanced Data rates for GSM Evolution (EDGE) systems, and the like.

The wireless communication network 10 includes a home network 12 and a roaming network 14 linked via an internet link as represented by the internet cloud 16. Although, an internet link 16 between the two networks 12 and 14 is shown, it will be appreciated by those of ordinary skill in the art that other communication links such as Signaling System 7 (SS7), Gigabit Ethernet, Asynchronous Transfer Mode (ATM), Frame Relay, any Wide Area Network (WAN) and Local Area Network (LAN), or the like may be utilized.

The home network 12 and the roaming network 14 are similar in architecture and, in one embodiment, can be a simple cellular network. The home network 12 includes various mobile devices or mobile stations (MSs) 18 that communicate with a radio access network (RAN) 20, such as a Base Transceiver Station (BTS), Radio Base Station (RBS), Node B in 3G Networks, Base Station (BS), Mobile Switching Centre (MSC), or the like. The network can be that of any of the wireless communication technologies known in the art, like GSM, CDMA, Wireless local loop (WLL), Wide Area Network (WAN), WiFi, WiMAX, etc. The RAN 20 may also include a packet control function (PCF) generally indicated by reference numeral 22 for establishing a link to a home wireless access gateway 24. Moreover, the PCF 22 helps in transporting packets between the RAN 20 and the home wireless access gateway 24.

The RAN 20 is in communication with the home wireless access gateway 24, for example a Packet Data Serving Node (PDSN), Gateway GPRS Support Node (GGSN), Serving GPRS Support Node (SGSN), remote access server, network access server, Digital Subscriber Link Access Multiplexer (DSLAM), IP-DSLAM, and the like. In one embodiment, the home wireless access gateway 24 includes a PDSN, which comprises a Layer 2 Tunneling Protocol (L2TP) Network Server (LNS) 26.

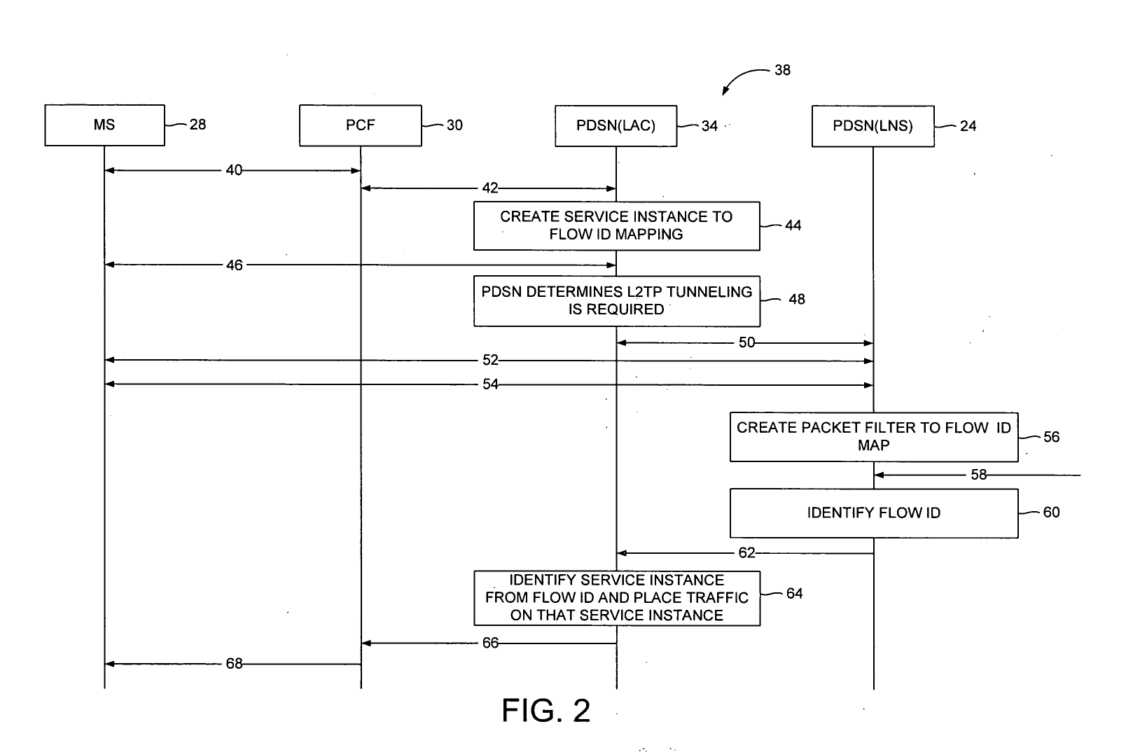

The roaming network 14 also includes various mobile devices 18 and 28, a RAN 30 including a PCF 32, and a roaming wireless access gateway 34. In one embodiment, the roaming wireless access gateway includes a PDSN, which comprises a L2TP Access Concentrator (LAC) 36. PDSN (LNS) 26 and PDSN (LAC) 36 are in communication with each other via the link 16. Transmission of packets within the network 10 will now be explained with the aid of FIG. 2.

FIG. 2 is a schematic representation of an exemplary packet flow within the wireless communication network 10 illustrated in FIG. 1. The packet flow diagram designated generally by reference numeral 38 illustrates components of wireless communication network 10, such as the MS 28, a RAN 30, a roaming wireless access gateway, which in one embodiment includes a PDSN (LAC) 34, and a home wireless access gateway, which in the present embodiment includes a PDSN (LNS) 24. These components are in communication with each other in the wireless communication network 10 of FIG. 1.

Initially, when the mobile station 28 travels to a roaming network 14, the MS 28 establishes an airlink or a wireless link with the radio access network or RAN 30, as indicated by step 40. The RAN 30 then links the MS 28 to the roaming wireless access gateway 34, which in the current embodiment includes a PDSN (LAC). This link may be established via the PCF 32, and can be performed by A10 or A11 procedures known in the art, as shown in step 42. However, other link establishment techniques may also be used. While establishing this link, the A10/A11 procedures transmit a flow identifier to the roaming wireless access gateway 34 in step 42. The flow identifier thus created (step 44) uniquely distinguishes the session between the MS 28 and the roaming wireless access gateway 34, so that the roaming wireless access gateway can identify and direct packets to their respective sessions. This ensures that the packets are not lost or delivered to other mobile stations 18 to which they are not destined to, thereby maintaining higher Quality of Service (QoS) during the session.

The MS 28 then performs the point-to-point protocol (PPP) negotiations (step 46) with the PDSN (LAC) or the roaming wireless access gateway 34. It will be appreciated by one of ordinary skill in the art that other link establishment techniques may also be used. The roaming wireless access gateway 34 determines in step 48 if tunneling is required. A communication link is established between the roaming wireless access gateway 34 and the home wireless access gateway 24. The tunneling requirement is determined via any authentication and authorization protocol such as, Authorization, Authentication, Accounting (AAA), RADIUS Authorization Authentication Accounting, DIAMETER Authorization Authentication Accounting, or the like. Alternatively, the determination can be made using a database look-up via Lightweight Directory Access Protocol (LDAP), Structured Query Language (SQL), or using any database protocol known in the art.

However, there may be cases where the roaming wireless access gateway 34 may itself service the MS 28. In such a case, tunneling may not be required between the two wireless access gateways 24 and 34. But, in cases where tunneling may be required, a tunnel is established via the point-to-point tunneling protocols. For example, the home wireless access gateway 24 and roaming wireless access gateway 34 establish a Layer 2 Tunneling Protocol (L2TP) tunnel or point-to-point tunneling protocol tunnel in step 50. The PPP negotiations are then completed between the home wireless access gateway 24 and the MS 28, as shown in step 52.

A routing protocol such as Resource Reservation Setup Protocol (RSVP) is used to create Traffic Flow Templates (TFTs) or a packet flow map, in step 54. The TFT generally includes packet filters mapped to IP flows. Further, these packet filters are installed at the home wireless access gateway 24 or PDSN (LNS) as represented by step 56. The packet filters determine the destination of the various IP packets that are received by the PDSN (LNS) 24 by appropriate filtering mechanisms and mapping with the flow identifier. In other words, a packet received by the PDSN (LNS) 24 can be directed to the corresponding session identified by the packet flow map.

When a packet is received by the PDSN (LNS) 24 as shown in step 58, the flow identifier is determined (step 60). The packet is tunneled through the L2TP tunnel (step 62) from the PDSN (LNS) 24 to PDSN (LAC) 34. This tunneled data includes the flow identifier within its header. Furthermore, the flow identifier may be included in the body or data portion of the tunneled message. Alternatively, the flow identifier may be transmitted separately. At the roaming wireless access gateway or PDSN (LAC) 34, the session corresponding to the received packet is determined using the flow identifier (step 64). Subsequently, the packet is placed on the correct session (step 64). The packet is then transmitted from the PDSN (LAC) 34 to the RAN 30 in the correct session in step 66 and then to the MS 28 (step 68).

It may be noted that identifying the flow identifier at the home wireless access gateway 24 and transmitting it through the header, body, or data portion of the tunneled data to the roaming wireless access gateway 34 allows the IP packets to be placed in their corresponding sessions. Thus, the packets are not lost, nor are they erroneously delivered to unintended mobile stations 18. Furthermore, this allows maintaining a high QoS characteristic and reducing error rate.

In the described embodiments, the mobile stations 18 may include any mobile device capable of communicating wirelessly with other mobile devices. For example, the MS 18 may include cellular phones, mobile computers, WLL phones, Personal Handy-phone System (PHS) or Personal Access System (PAS) phones, and the like. Various types of calls such as a voice call, a data call, a video call, a multimedia call or any transmission of packets that occurs between the mobile station 18 and the wireless access gateways 24 and 34, can be established.

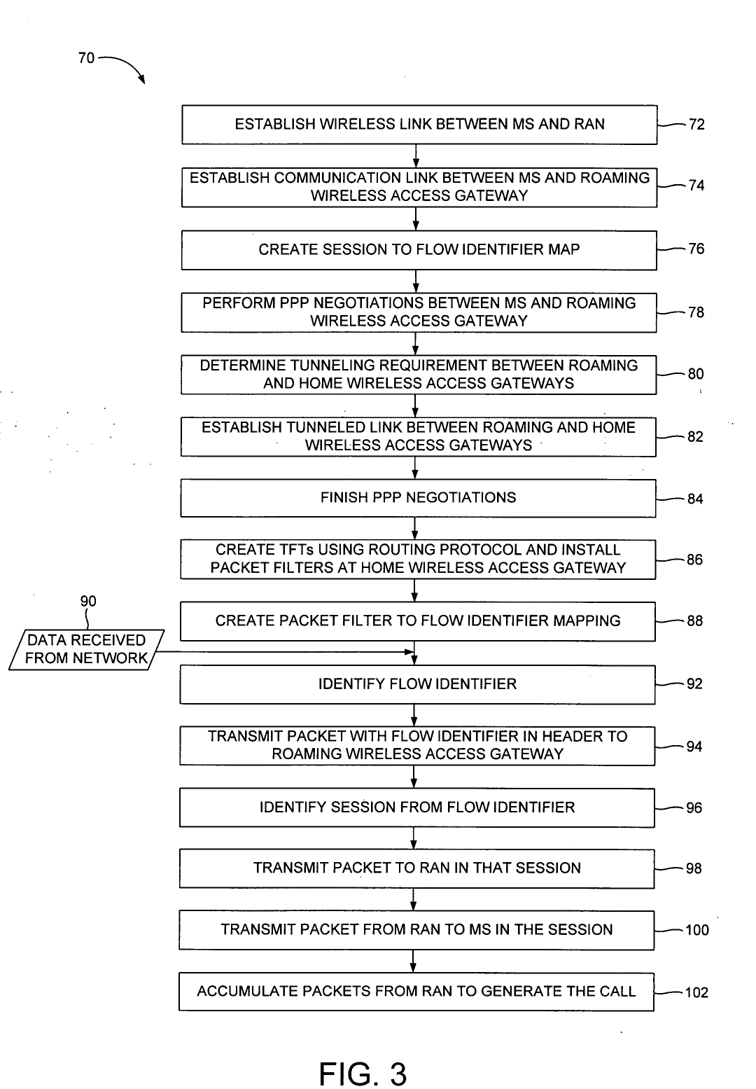

Turning now to FIG. 3, a flow chart illustrating the process of packet flow 70 in the wireless communication network 10 of FIG. 1 in accordance with certain embodiments of the present technique will be described. The packet flow process 70 and its various blocks may comprise software, hardware, or specific code executable by a suitable processor-based device. In the illustrated embodiment, the process 70 begins with the MS 28 establishing an airlink or a wireless link with the RAN 30 (block 72). By representing traffic and signal paths for RAN-roaming wireless access gateway using A10 and A11 procedures, or other such procedures known in the art, packet data services are established between the MS 28 and the roaming wireless access gateway 34 via the RAN 30 (block 74).

A session to flow identifier map is created to facilitate identification of the session to which a packet flow should be directed (block 76). PPP negotiations are performed between the MS 28 and the roaming wireless access gateway 34 (block 78) for establishing IP link layer connectivity between the MS 28 and the network to transport the IP packets. The process 70 determines tunneling requirement by the roaming wireless access gateway 34 (block 80) and establishes a tunnel between the roaming wireless access gateway 34 and the home wireless access gateway 24 (block 82). The PPP negotiations are completed between the home wireless access gateway 24 and the MS 28 (block 84).

TFTs are created using a routing protocol and packet filters are installed at the home wireless access gateway 24 (block 86), while packet filter to flow identifier mapping is performed at the home wireless access gateway to identify and direct packets to respective sessions (block 88). When a data packet is received from the network (block 90), the flow identifier is retrieved (block 92), and the packet is transmitted or tunneled along with the flow identifier in the header to the roaming wireless access gateway 34 (block 94). Using the flow identifier, the corresponding session is identified by the roaming wireless access gateway 34 (block 96) and the packet is transmitted to the RAN 30 (block 98) and subsequently from RAN to the MS 28 (block 100). All such packets are collected and the call is created (block 102). It may be noted that the above steps may be implemented in any order and that the described order is one such implementation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while certain implementations of the invention have been described, it is to be understood that aspects of the invention may include only some of the described embodiments. Accordingly, the invention is not to be seen as limited by the foregoing description, but is only limited by the scope of the appended claims.

1. A method for transmitting a packet in a network, the method comprising:
establishing a session with a flow identifier between a mobile station and a roaming wireless access gateway via a radio access network;
establishing a communication link between a home wireless access gateway and the roaming wireless access gateway;
maintaining a filter at the home wireless access gateway for packet flow between the home wireless access gateway and the mobile station;
identifying the flow identifier for a packet received by the home wireless access gateway from the network;
transmitting the packet with the flow identifier from the home wireless access gateway to the roaming wireless access gateway; and
identifying the session for the packet via the flow identifier.

2. The method of claim 1, wherein establishing the session comprises establishing a wireless link between the mobile station and the radio access network.

3. The method of claim 1, wherein establishing the session comprises establishing the session between the radio access network and the roaming wireless access gateway via A10 procedure or A11 procedure.

4. The method of claim 1, wherein establishing the communication link comprises determining a tunnelling requirement between the home wireless access gateway and the roaming wireless access gateway.

5. The method of claim 1, wherein establishing the communication link comprises establishing a tunneled communication link between the home wireless access gateway and the roaming wireless access gateway.

6. The method of claim 1, wherein maintaining the filter comprises generating a packet filter via a routing protocol.

7. The method of claim 1, wherein maintaining the filter comprises filtering the packet for the packet flow using the flow identifier between the home wireless access gateway and the mobile station.

8. The method of claim 1, wherein identifying the flow identifier comprises identifying the flow identifier for the packet using a packet flow map.

9. The method of claim 1, wherein transmitting the packet comprises tunneling the packet with the flow identifier from the home wireless access gateway to the roaming wireless access gateway.

10. The method of claim 1, wherein identifying the session comprises transmitting the packet from the roaming wireless access gateway to the mobile station through the radio access network in the session.

11. A method for establishing a call to a mobile station in a roaming network from a home network, the method comprising:
establishing a packet flow session with a flow identifier between a mobile station and a roaming wireless access gateway;
establishing a communication link between a home wireless access gateway and the roaming wireless access gateway;
maintaining a filter at the home wireless access gateway for packet flow between the home wireless access gateway and the mobile station;
identifying the flow identifier for a packet received by the home wireless access gateway from the network;
transmitting the packet with the flow identifier from the home wireless access gateway to the roaming wireless access gateway;
identifying the session for the packet via the flow identifier at the roaming wireless access gateway and transmitting the packet to the mobile station; and
combining the packet with a plurality of packets for delivering a call to the mobile station.

12. The method of claim 11, wherein establishing the packet flow session comprises establishing a wireless link between the mobile station and a radio access network.

13. The method of claim 12, wherein establishing the packet flow session comprises establishing the packet flow session between the radio access network and the roaming wireless access gateway.

14. The method of claim 11, wherein establishing the communication link comprises establishing a tunneled communication link between the home wireless access gateway and the roaming wireless access gateway.

15. The method of claim 11, wherein transmitting the packet comprises tunneling the packet with the flow identifier from the home wireless access gateway to the roaming wireless access gateway.

16. The method of claim 11, wherein combining the packet comprises combining the packet with the plurality of packets for delivering a voice call to the mobile station.

17. The method of claim 11, wherein combining the packet comprises combining the packet with the plurality of packets for delivering a data call to the mobile station.

18. The method of claim 11, wherein combining the packet comprises combining the packet with the plurality of packets for delivering a video call to the mobile station.

19. The method of claim 11, wherein combining the packet comprises receiving the plurality of packets by the radio access network.

20. A method for transmitting a packet within a network, the method comprising:
establishing a session with a flow identifier between a mobile station and a roaming packet data serving node via a radio access network;
establishing a tunneled communication link between a home packet data serving node and the roaming packet data serving node;
filtering the packets for determining packet flow via flow identifier between the home packet data serving node and the mobile station;
identifying the flow identifier for a packet received by the home packet data serving node from the network;
tunneling the packet and the flow identifier from the home packet data serving node to the roaming packet data serving node; and
identifying the session for the packet via the flow identifier for transmitting the packet from the roaming packet data serving node to the mobile station through the radio access network within the session.
